(19) United States
(12) Patent Application Publication
(10) Pub. No.: US 2023/0313452 A1
(43) Pub. Date: Oct. 5, 2023

(54) Textile Fabric, Clothing, Method for Producing or Functionalizing a Textile Fabric and Uses of a Photosensitizer Bonded to a Textile Fabric

(71) Applicant: Ortner Cleanroom Engineering GmbH, Villach (AT)

(72) Inventors: Beate Roeder, Falkensee (DE); Birgit Armbruster, Greiz (DE); Wolfram Kofler, Seeboden (AT)

(21) Appl. No.: 18/003,676

(22) PCT Filed: May 26, 2021
(86) PCT No.: PCT/EP2021/064045

§ 371 Date: Dec. 28, 2022

(30) Foreign Application Priority Data
Jun. 29, 2020 (EP) 20182844.9

(51) Int. Cl. D06P 5/20

(52) U.S. Cl. CPC D06P 5/2005; D06P 1/44

(57) ABSTRACT

A textile fabric woven and/or nonwoven, wherein the woven and/or nonwoven fabric includes fibers optionally having at least in part a coating, wherein a dye, which has an antimicrobial effect when activated with electromagnetic radiation, is bonded to the fibers or to and/or in the coating. Clothing made from the textile fabric, methods for producing or functionalizing a textile fabric, and uses of a photosensitizer bonded to a textile fabric are described.

### CROSS REFERENCE TO RELATED APPLICATIONS

This application is the U.S. national phase of International Application No. PCT/EP2021/064045 filed May 26, 2021, which designated the U.S. and claims priority to European Patent Application No. 20182844.9 filed Jun. 29, 2020, the entire contents of each of which are hereby incorporated herein by reference.

### TECHNICAL FIELD

Embodiments of the disclosure relate to a textile fabric, a clothing (textiles, garments) made therefrom, a method for producing or functionalizing a textile fabric, and uses of a photosensitizer bonded to a textile fabric.

### BACKGROUND ART

Clothing and textiles offer an excellent substrate for microbial germs due to their high internal surface area and mostly good moisture absorption. Therefore, antimicrobial finishing of textiles appears to be particularly useful in the medical and technical sectors. At present, mainly classic biocides, such as triclosan, quaternary ammonium compounds and polyhexanide, but also silver nanoparticles, heavy metals or chitosan are used for this purpose.

An approach based on photodynamic inactivation (PDI) for the antimicrobial finishing of textiles offers a promising and environmentally friendly way to circumvent the problem of microbial resistance in particular. PDI is based on the photosensitized activation of reactive oxygen species (ROS), which can oxidize cell components of microorganisms directly or via the formation of secondary radicals and ultimately lead to cell death (e.g., by destroying the protein envelope) or inactivation. The activation mechanism is based on the effect of light of the visible or ultraviolet spectrum on a dye (also called photosensitizer) acting as photosensitizer (PS). This transfers its light-induced excitation energy to surrounding oxygen molecules, resulting in the formation of highly reactive singlet oxygen (¹O₂). Thereafter, the PS returns to its ground state and is available for re-excitation. In the case of microorganisms, it is unimportant whether photosensitization is induced from within the cells, the cell membrane or outside the cell. This is the strength of the principle of PDI: In contrast to the mode of action of antibiotics, which is linked to very specific metabolic processes or cell components, PDI acts via nonspecific oxidation processes and is also independent of pre-existing resistance mechanisms.

Previous attempts for PDI-based textile functionalization are mainly based on covalent coupling mechanisms or eSpin processes. Both strategies have the disadvantage that they are cost-intensive and in some cases very complex. For example, covalent coupling usually requires an asymmetric substitution of the PS and a bond-specific activation of the substrate. Industrially, eSpin processes can be implemented much more universally, but because of their low process efficiency they are still predominantly limited to small special applications. Another disadvantage of eSpin processes is that the PS is mainly immobilized inside the substrate and not on its surface. Due to the limited ¹O₂ diffusion, a large proportion of the PS molecules thus remains ineffective.

A problem that has not yet been solved in the functionalization of textile materials with photosensitizers lies in particular in binding the photosensitizer sufficiently firmly to the textile substrate to prevent the dye from being washed out as far as possible when the textile is washed, without impairing its antimicrobial efficacy. For protective clothing and cleanroom clothing in particular, a wash-resistant PDI-based functionalization offers an economically and ecologically advantageous alternative, which is also continuously effective in the presence of light, to conventional disposable protective suits or textiles that always require an elaborate sterilization.

Unfortunately, it has furthermore turned out that there is still a great danger from pathogenic microorganisms, including viruses, as most recently demonstrated by the severe acute respiratory syndrome coronavirus 2 (SARS-CoV-2) and the Covid-19 disease caused by this virus, so that there is a great demand to provide textile materials effectively and as permanently as possible (in particular durable or wash-resistant) with biocidal or antimicrobial properties in order to prevent a transmission of pathogens as far as possible and to protect the wearer of the clothing from an infection.

Thus, there may be a need to provide textile materials or textile fabrics, as well as clothing made therefrom, with a photodynamic inactivation which is effective and as permanent as possible (in particular durable or wash-resistant) and which may be capable of significantly reducing the number of germs on the surface (preferably by more than 10⁴ (“log 4”) or specifically killing or inactivating bacteria and viruses, thereby not only protecting the wearer of the clothing from infection, but also minimizing the risk of transmission.

### SUMMARY

Embodiments of the present disclosure relate to a textile fabric comprising a woven and/or nonwoven fabric, wherein the woven and/or nonwoven fabric comprises fibers optionally having at least in part (partially) a coating, wherein a dye (photosensitizer), which has an antimicrobial effect when activated (by activation) with electromagnetic radiation, is bonded (bound) to the fibers or to and/or in the coating (in particular permanently or substantially irreversibly).

Another exemplary embodiment relates to clothing (garment, textile) comprising, in particular made of, a textile fabric as described herein.

Still another exemplary embodiment relates to a method for producing or functionalizing a textile fabric or a woven and/or nonwoven fabric comprising fibers, the method comprising optionally at least partially coating the fibers, applying a dye (photosensitizer), which has an antimicrobial effect when activated with electromagnetic radiation, to the textile fabric and binding the dye to the fibers or to and/or in the coating.

Still another exemplary embodiment relates to a textile fabric obtainable (or obtained) by a method having the above features.

In addition, another exemplary embodiment relates to the use of a photosensitizer bonded to a textile fabric (or to a woven and/or nonwoven fabric) for controlling microbial, in particular bacterial and/or viral, growth or for reducing a microbial, in particular bacterial and/or viral, load.

Further objects and advantages of embodiments of the present disclosure will become apparent with reference to the following detailed description and the accompanying figures.

### BRIEF DESCRIPTION OF THE DRAWINGS

FIG. 1 shows photographs of textile fabrics functionalized with a dye. Samples with binder system and with post-treatment (PS-PET), without post-treatment (PS-PET*), without binder system and without post-treatment (PS-PET**) and, as a comparison, an untreated reference substrate (Ref-PET) are shown.

FIG. 2 shows Kubelka-Munk function determined from DRUV spectra of the three samples shown in FIG. 1. The spectra were recorded against a zero sample of the same textile substrate but without TMPyP functionalization as a standard. The normalized absorption spectrum of TMPyP in H₂O is shown in dashed for comparison.

FIG. 3 shows absorbance spectra measured in EtOH extract after 48-hour incubation (1.6 × 1.6 cm tissue in 6 ml EtOH) of the sample PS-PET in comparison to two non-post-treated sample variants PS-PET* and PS-PET** (staining with and without binder system). An enlarged section is also shown for samples PS-PET* and PS-PET.

FIG. 4 illustrates the time-resolved ¹O₂ detection on the functionalized sample surfaces as a function of the microenvironment (dry/wet). 6 × 6 pixel grids of 1 mm increments were scanned under a quartz glass plate. The displayed signals were summed over all 36 measurement pixels. The signals normalized to the maximum are shown on the right side.

FIG. 5 shows exemplary photos of the samples incubated with M. luteus as a hand test of dark toxicity and phototoxicity. For the determination of phototoxicity, 4 textile pieces of each sample were irradiated with 11 mW/cm² white light for 1 h. The samples were incubated with M. luteus. M. luteus is a yellow germ and therefore difficult to photograph on the equally yellow textile samples. The yellow color on the zero samples (white without germ) originates exclusively from M. luteus.

FIG. 6 illustrates a photodynamic inactivation (PDI) of E. coli on the sample PS-PET as well as the zero sample (Ref-PET) as reference after 5, 10, and 30 min. Irradiation with white light was performed at 11 ± 2 mW/cm². The error bars correspond to the standard deviation from 12 counts (n=12). The count limit is marked by dashed lines. The relative rate is normalized to the dark incubated zero sample.

### DETAILED DESCRIPTION OF EXEMPLARY EMBODIMENTS

Hereinafter, details of the present disclosure and further embodiments thereof will be described. However, the present disclosure is not limited to the following detailed description, but is rather only for illustrative purposes of the inventive teachings.

It should be noted that features described in connection with an exemplary embodiment may be combined with any other exemplary embodiment. In particular, features described in connection with an exemplary embodiment of a textile fabric according to the disclosure may be combined with any other exemplary embodiment of a textile fabric according to the disclosure, as well as with any exemplary embodiment of a clothing according to the disclosure, as well as any exemplary embodiment of a method according to the disclosure, as well as any exemplary embodiment of a use according to the disclosure, and vice versa, unless specifically stated otherwise.

Where an indefinite or definite article is used when referring to a singular term, such as “a”, “an” or “the”, a plural of that term is also included and vice versa, unless the context clearly dictates otherwise. The expressions “comprise” or “have”, as used herein, not only include the meaning of “contain” or “include”, but may also mean “consist of” and “consist essentially of”.

In a first aspect, an exemplary embodiment relates to a textile fabric.

In the context of the present application, the term “textile fabric” is understood to mean a two-dimensional textile product, which may in particular be woven or nonwoven. A textile fabric is particularly suitable for the manufacture of clothing (including (face or mouth-nose) masks) or a garment therefrom, but can equally be used for the manufacture of covers (for example covers for furniture, such as seat covers in airplanes, trains, buses, or automobiles, covers for packages), curtains, bedding, cleaning cloths, cleaning rags, packaging material etc.

The textile fabric comprises a woven fabric (i.e., in particular a woven cloth) and/or a nonwoven fabric (i.e., in particular a nonwoven cloth). Both the woven fabric and the nonwoven fabric have fibers, which in the case of a woven fabric are also referred to as threads. In particular, the woven fabric or the nonwoven fabric may be substantially composed of fibers. While in the case of a woven fabric, the fibers (or threads) are typically arranged in a regular manner (for example, as warp threads and weft threads, which may be arranged substantially at right angles to each other, for example), in the case of a nonwoven fabric, the fibers are usually intertwined with each other in an irregular manner.

According to an exemplary embodiment, the fibers comprise polyester fibers, cellulose fibers, or combinations thereof. These types of fibers allow a particularly advantageous bonding of a dye or an optional coating. In addition, polyester fibers are particularly suitable for cleanroom clothing due to their high resistance to wear, and cellulose fibers are particularly suitable for protective clothing or workwear, including clothing in laboratories, in the food-producing industry or in clinical environments, due to their wear comfort and lack of meltability. Particularly suitable polyester fibers include, for example, polyethylene terephthalate (PET) fibers. Particularly suitable cellulose fibers include, for example, cotton fibers. Also, combinations of polyester and cellulose fibers have proven advantageous.

The fibers may have at least in part a coating. In other words, at least a part of the fibers may be coated. The coating may serve to have bonded thereto (i.e., to a surface of the coating) and/or therein (for example, embedded therein) a photosensitizer as described in further detail below. Thus, the coating may in particular provide a binder or adhesion promoter between the fiber and the photosensitizer. To this end, it may be advantageous if the coating comprises a polymer, for example a (self-) crosslinking polymer, which may form, for example, a polymer matrix in which the photosensitizer may be embedded and/or on the surface of which the photosensitizer may be bonded (in particular adsorbed). For example, the polymer may be a melamine formaldehyde resin.

The textile fabric further comprises a dye which exhibits an antimicrobial effect when activated with electromagnetic radiation. Such a dye is also referred to as a “photosensitizer” in the context of the present application.

In the context of the present application, the term “activated/activation with electromagnetic radiation” is understood to mean, in particular, an irradiation with visible light (e.g., with a wavelength of from 400 to 800 nm, in particular from 400 to 720 nm) and/or with light in the UV range (e.g., with a wavelength of from 200 to 400 nm, in particular from 320 to 400 nm). Preferably, the electromagnetic radiation is light in the visible range, such as it is naturally emitted by the sun or can also be artificially generated by a light source. Without wishing to be bound by any theory, reactive oxygen species, in particular singlet oxygen (O¹₂), can be formed from oxygen (such as present in the air) during such activation of the photosensitizer, which exert a (generally non-specific) antimicrobial effect.

In the context of the present application, an “antimicrobial effect” is understood to mean the ability to kill microorganisms, such as bacteria, viruses, yeasts, and fungi, or at least to control or restrict their growth. According to an exemplary embodiment, in the context of the present application, an “antimicrobial effect” is understood to mean an antibacterial and/or antiviral effect or property, and may in particular comprise a bacteriostatic, bactericidal, virostatic and/or virucidal effect or property, including a (bacteriostatic and/or bactericidal) effect against gram-positive as well as gram-negative bacteria, and/or a (virostatic and/or virucidal) effect against coronaviruses (family Coronaviridae), such as the severe acute respiratory syndrome coronavirus 2 (SARS-CoV-2).

According to an exemplary embodiment, the dye (photosensitizer) is selected from the group consisting of a porphyrin dye, a xanthene dye, and a phthalocyanine dye. These classes of substances have been found to be particularly suitable for providing sufficient strength in binding to the textile substrate while retaining their photo-induced antimicrobial activity. As will be understood by one skilled in the art, combinations of these dye classes may also be used in an advantageous manner.

According to an exemplary embodiment, the dye (photosensitizer) is selected from the group consisting of TMPyP (α,β,γ,δ-tetrakis(1-methylpyridinium-4-yl)porphyrin p-toluene sulfonate; CAS number 36951-72-1), Eosin Y (2′,4′,5′,7′-tetrabromofluorescein disodium salt; CAS number 17372-87-1), Rose Bengal (4,5,6,7-tetrachloro-2′,4′,5′,7′-tetraiodofluorescein disodium salt; CAS number 11121-48-5), and ZnPcF16 (zinc perfluorophthalocyanine; CAS number 31396-84-6). The structural formulas of these particularly suitable dyes are given below:

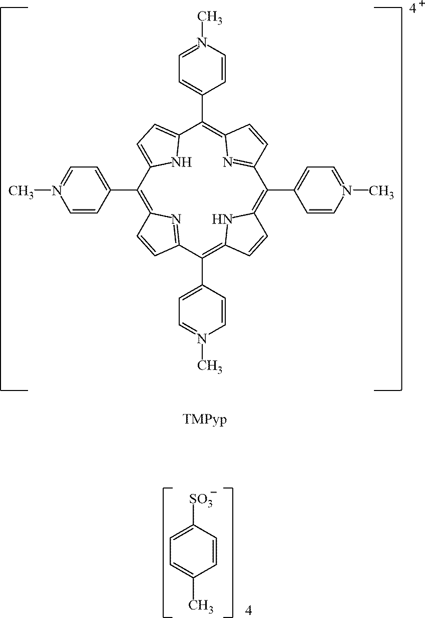

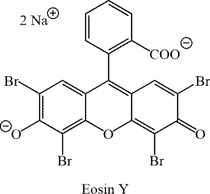

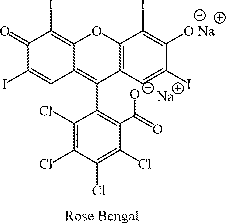

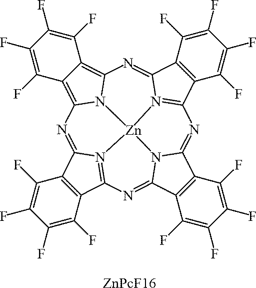

Among them, in particular TMPyP and Eosin Y, and of these especially TMPyP, have proven to be particularly suitable dye(s) for providing sufficient strength in binding to the textile substrate while retaining its/their photo-induced antimicrobial activity. Of course, in an advantageous manner, the mentioned dyes can also be used in combination.

The dye (photosensitizer) is bonded to the fibers or to and/or in the coating (in particular permanently or largely irreversibly). Preferably, the dye is so tightly bonded to the fibers or to and/or in the coating that it cannot be easily dissolved out (for example when washing the textile fabric with water and optionally laundry detergent) and substantially retains its photo-inducible antimicrobial efficacy even in the bonded state.

According to an exemplary embodiment, the dye (photosensitizer) is adsorbed onto the fibers (in particular onto a surface of the fiber) or onto a surface of the coating and/or embedded in the coating. Adsorption of the photosensitizer to a surface of the fiber or coating may be advantageous, in particular with regard to a high antimicrobial efficacy, since on the one hand the dye can be exposed to activating radiation largely unhindered and on the other hand the reactive oxygen species (such as singlet oxygen) formed by the photosensitized activation can diffuse largely unhindered to their desired site of action (i.e., the microorganism to be controlled). On the other hand, embedding the photosensitizer in the coating (for example, in a polymer matrix) may be advantageous, in particular in terms of high strength or durability of the bond, while still providing good antimicrobial efficacy. A combination of adsorption of the photosensitizer on a surface and its embedding may also be advantageous.

According to an exemplary embodiment, the dye (photosensitizer) is bonded to the fibers or to the coating via ionic interactions and/or covalently. In this way, a particularly strong bond can be achieved. In an exemplary embodiment, however, the dye (photosensitizer) can also be molecularly dissolved in the coating (i.e., the dye can diffuse or migrate, and is not chemically bonded to the coating).

According to an exemplary embodiment, the dye (photosensitizer) is bonded to the fibers or to the coating via ionic interactions. In an embodiment, the dye may contain functional cationic groups for this purpose, such as ammonium groups, quaternary ammonium groups, protonated nitrogen heterocycles (such as pyridinium groups), phosphonium groups, or quaternary phosphonium groups. These cationic groups may interact with anionic groups present in the coating or the fiber, such as carboxylate groups, sulfonate groups, sulfenate groups, phosphonate groups, phosphinate groups, whereby an ionic bonding may be achieved. In a further embodiment, the dye may contain anionic functional groups for this purpose, such as carboxylate groups, sulfonate groups, sulfenate groups, phosphonate groups, phosphinate groups, etc. These anionic groups may interact with cationic groups present in the coating or the fiber, such as ammonium groups, quaternary ammonium groups, protonated nitrogen heterocycles (such as pyridinium groups), phoshonium groups, quaternary phosphonium groups, whereby an ionic bonding may be achieved.

According to an exemplary embodiment, it has been found advantageous if the fibers are partially negatively charged and the dye is partially positively charged, or if the fibers are partially positively charged and the dye is partially negatively charged; in other words, if the fibers and the dye have opposite (and thus attractive) charges.

According to an exemplary embodiment, the dye (photosensitizer) is covalently bonded to the fibers or to the coating. In an embodiment, the dye may have coupleable groups for this purpose that can react with corresponding coupleable groups of the coating or the fiber to form a covalent bond. Examples of suitable reactive coupleable groups include hydroxyl, hydroxyalkyl, amino, aminoalkyl, mercapto, mercaptoalkyl, epoxy, glycidyl, carboxyl, vinyl, allyl, acrylate, methacrylate groups, as well as isocyanate and isothiocyanate groups. Depending on the nature and reactivity of the chemical groups, this coupling reaction can take place, for example, via addition reactions, polymerization reactions or condensation reactions and result in the formation of, for example, ester groups, amide groups, ether groups, sulfide groups, urethane groups, urea groups, thiourea groups, or linkages between carbon atoms.

According to an exemplary embodiment, the dye (photosensitizer) is directly bonded to the fiber or the coating, as illustrated above, among other things.

According to another exemplary embodiment, the dye (photosensitizer) is bonded to the fiber or coating via an intermediate group (which may also be referred to as a spacer or a linker). This may be particularly advantageous if the dye (or its functional groups) has a low affinity or binding tendency to the fiber or coating. In this case, the intermediate group may be referred to in particular as a linker. However, it may also be advantageous for steric reasons not to couple the photosensitizer directly to the fiber or coating, but via an intermediate group. In such a case, the intermediate group may be referred to in particular as a spacer. Of course, several (for example different) intermediate groups may also be used, which may be arranged in parallel (next to each other) and/or serially (one behind the other, i.e., via a chain of intermediate groups).

Another exemplary embodiment relates to clothing (for example textiles) comprising, in particular made from, a textile fabric as described above.

According to an exemplary embodiment, the clothing is protective clothing or workwear (including clothing in a laboratory, in a clinic or hospital or in the food-producing industry) and/or cleanroom clothing. In the context of the present application, the term “protective clothing” is understood to mean, in particular, any form of clothing or garments (including protective masks such as mouth-nose masks) that can protect the wearer (usually a human being) from harmful influences, in particular - but not only - from harmful influences caused by microorganisms such as bacteria and/or viruses. This includes, in particular, (protective) clothing suitable or intended for use in a laboratory, in a clinic or hospital or in the food-producing industry, including (face or mouth-nose) masks, but also (protective) clothing suitable or intended for wearing outside of buildings. In the context of the present application, the term “workwear” is understood to mean, in particular, any form of clothing or garment generally suitable or intended for wearing when performing (mental and/or physical) work both inside and outside buildings. In the context of the present application, the term “cleanroom clothing” is understood to mean, in particular, (protective) clothing which is worn in a cleanroom and which is accordingly subject to particularly high requirements in terms of microbial (and also other) cleanliness.

In a further aspect, still another exemplary embodiment relates to a method for producing or functionalizing a textile fabric (in particular for producing a textile fabric according to the first aspect) or a woven and/or nonwoven fabric comprising fibers. All further details concerning the textile fabric as described above may apply to the method according to the disclosure.

According to an exemplary embodiment, the fibers may be at least partially coated. This may be done, for example, by applying a polymer composition or another composition suitable for coating. However, coating may also be carried out together (i.e., in one process step) with the application of the dye (photosensitizer).

According to an exemplary embodiment, the application of the dye includes an impregnation of the textile fabric with a composition containing the dye. In particular, a foulard process (i.e., a process using a foulard) can be used for this purpose, as exemplified below together with further process steps such as binding and post-treatment. A foulard typically includes a system of two or more rollers and a trough (also referred to as a chassis) for accommodating a dye liquor. In the foulard process, the textile fabric is immersed in the liquor typically in the wide state and then rollers are used to remove the excess of absorbed liquor uniformly across the width of the fabric. To prepare the dye liquor, the dye can be dissolved at a concentration of, for example, 0.01 wt.% to 1 wt.% in a binder system with crosslinker and optionally other textile auxiliaries and filled into the chassis. The textile fabric is impregnated in the chassis and squeezed off via the foulard rollers. The proportion remaining on the textile after squeezing is referred to as liquor pick-up and is preferably between 50% and 80%. The textile material can then be dried and condensed, for example in a stenter-dryer and fixer under defined conditions at a temperature of 120° C. to 150° C. To remove the non-fixed dye and to improve the color fastnesses, a post-treatment with a universal detergent is carried out at a temperature of 60 – 90° C. and a residence time between 10 - 40 min, followed by a drying process.

Alternatively, the dye may also be applied in an exhaust process, as described below together with further process steps such as binding and post-treatment. In an exhaust process, the dye is typically dissolved in the dye liquor and is drawn out of the liquor and onto the textile material due to the long treatment time. The process typically involves the supply of the dye to the textile material, its adsorption onto the fiber surface, a diffusion into the fiber, and finally its physical bonding with or to the fiber. Dyeing in the exhaust process may be carried out in a wide state with moving liquor or as a continuous strand with standing liquor with a liquor ratio of 1:10 to 1:80. The liquor ratio describes the ratio of the dry weight of the material to be dyed to the dye liquor present in the dyeing unit. To prepare the dye liquor, the dye may be dissolved at a concentration of, for example, 0.01 wt.% to 1.5 wt.% in water and optionally other textile auxiliaries (wetting and leveling auxiliaries) and poured into the dyeing unit at room temperature. The dye liquor is heated, for example, at 0.5 – 3° C. / min to a temperature between 80 - 140° C. The dyeing may be carried out over a residence time of 45 min to 60 min. Excess and unfixed dye may be removed with hot and cold rinsing processes. A reductive post-treatment using caustic soda, hydrosulfite, and a dye-affine detergent may also be performed to improve the color fastness. The post-treatment is typically carried out at a temperature between 60 – 90° C. and a residence time between 10 - 40 min, followed by several rinsing processes, followed by a drying process.

According to an exemplary embodiment, the binding of the dye involves ionic interactions between the dye and the fibers or the coating. For this purpose, corresponding functional cationic or anionic groups of the dye and the fibers or the coating, respectively, as described in detail above, may interact with each other without requiring any special reaction or other explicit intervention.

According to another exemplary embodiment, the binding of the dye involves a chemical reaction to form a covalent bond between reactive groups of the dye and reactive groups of the fibers or the coating. Such a coupling reaction may take place - depending on the nature and reactivity of the chemical groups as described in detail above - for example via addition reactions, polymerization reactions, or condensation reactions and result in the formation of, for example, ester groups, amide groups, ether groups, sulfide groups, urethane groups, urea groups, thiourea groups, or linkages between carbon atoms. Similarly, provision may be made for the use of a catalyst that accelerates or facilitates the coupling reaction. Furthermore, the use of a coupling reagent may also be provided to accelerate or simplify the coupling. The coupling reaction may be carried out at different temperatures, which are preferably in the temperature range of from 20° C. to 180° C.

In an exemplary embodiment, a dye equipped with a reactive chemical group may be dissolved and reacted in a coating such that the dye is covalently bonded within the coating to the coating or components thereof. The coupling reaction may occur prior to application or after application of a coating to a woven and/or nonwoven fabric, also the coupling reaction may occur during a subsequent process step such as a drying of the coating, a thermal curing of the coating, or a thermal post-treatment.

In another exemplary embodiment, the dye may be reacted with the surface of the fiber or coating (including near-surface layers thereof) such that the dye is coupled to the surface of the fiber or coating. In this embodiment, the coupling reaction preferably occurs after a coating is applied to a woven and/or nonwoven fabric, also the coupling reaction may occur during a subsequent process step such as a drying of the coating, a thermal curing of the coating, or a thermal post-treatment at an elevated temperature.

According to another exemplary embodiment, the binding of the dye comprises embedding the dye in a polymer matrix of the coating, for example in a curing polymer matrix of the coating. Here, it may be advantageous if the coating and the application are performed in one step. Furthermore, it may be advantageous to perform the embedding, in particular a curing of the polymer matrix, at an elevated temperature, for example in the range of from 80° C. to 180° C., in particular in the range of from 120° C. to 150° C.

According to another exemplary embodiment, the method further comprises a post-treatment for removing unbonded or non-fixed dye. Such a post-treatment may be carried out in particular after the step of binding the dye. For this purpose, for example, the textile fabric may be washed or cleaned with a surfactant (in particular an anionic or nonionic surfactant).

According to an exemplary embodiment, the textile fabric is obtainable by a method as described above.

Still another exemplary embodiment relates to the use of a photosensitizer bonded to a textile fabric (or to a woven and/or nonwoven fabric) for controlling microbial, in particular bacterial and/or viral, growth, or to the use of a photosensitizer bonded to a textile fabric (or to a woven and/or nonwoven fabric) for reducing a microbial, in particular bacterial and/or viral, load.

According to an exemplary embodiment, the photosensitizer is bonded to the textile fabric by a method as described herein. Also, any further details regarding the textile fabric as described above may apply to the use according to the disclosure.

According to an exemplary embodiment, the photosensitizer is used to deactivate bacteria and/or viruses, in particular by at least log 3 (i.e., by at least 3 powers of ten), preferably by at least log 4 (i.e., by at least 4 powers of ten), in particular by at least log 5 (i.e., by at least 5 powers of ten).

According to an exemplary embodiment, the viral load or viruses include RNA viruses, in particular coronaviruses.

According to an exemplary embodiment, the viral load or viruses include the severe acute respiratory syndrome coronavirus 2 (SARS-CoV-2).

The present disclosure is further described by reference to the following examples, which, however, serve only to illustrate the teachings of the disclosure and are in no way intended to limit the scope of the present disclosure.

### EXAMPLES

### Functionalization of a Textile Substrate

TMPyP (CAS 36951-72-1, Sigma Aldrich Co. LLC.) was used as the photosensitizer (PS). This is a fourfold cationic porphyrin that has a broad spectrum of activity against Gram-positive and Gram-negative bacteria. A commercially available polyester substrate was used as the textile material. To favor coupling with the TMPyP, a cationic dyeable fabric was chosen.

Functionalization was carried out by impregnation in the foulard process at a TMPyP concentration of approx. 0.1 wt.% in the dye liquor. Optionally, a commercial binder system with crosslinker of the Sera family from DyStar (DyStar Colours Distribution GmbH) was used. This binder is present in a non-ionic synthetic polymer dispersion. During foulardation, the dye adsorbed in the binder system, i.e., embedded in a kind of polymer matrix, is squeezed into the textile substrate by means of rollers. Optionally, after dyeing, the samples were subjected to a post-treatment to remove poorly bonded TMPyP molecules and thus increase the fastness to washing. For this purpose, the samples were post-cleaned with anionic surfactants and non-ionic detergent.

### Samples Examined

Three different sets of samples were functionalized and compared with each other. The designations of the investigated samples used in the following are:
Ref-PET unprocessed reference substrate
PS-PET functionalized with binder and post-treatment
PS-PET* functionalized with binder without post-treatment
PS-PET** functionalized without binder without post-treatment

### Evaluation of the Sample Staining

The staining was verified by visual inspection, diffuse reflectance spectroscopy in UV-VIS (DRUV), and spatially resolved fluorescence scans. In addition, the samples were rinsed in H₂O, PBS, EtOH, and a bacterial suspension to ensure that no PS was extracted during PDI and confound the effect of the functionalized tissue. DRUV spectra of the functionalized samples were recorded using an absorption spectrometer (UV-2450, Shimadzu Deutschland GmbH) with an integrating sphere (Ulbricht sphere) attachment (ISR-240A, also Shimadzu). Non-functionalized PET⁺ tissue was used as standard. The Kubelka-Munk function F(R) is used to plot the spectra.

### Time-Resolved NIR Luminescence Scanning

Surface measurements of time-resolved NIR luminescence were made by a TCMPC system (SHB-analytics) and a NIR-optimized PMT detector (Hamamatsu). The channel width of the TCMPC is 80 ns with a total number of 4096 channels. The pulse width of the excitation pulse is 240 ns, resulting in an excitation energy of approximately 0.3 µJ/pulse. Two detection optics were used for the measurements performed here. One optics at 1270 ± 20 nm (FWHM resp. full width at half maximum) optimized for the spectral range of ¹O₂ luminescence and one optics at 1200 ± 15 nm (FWHM). Finally, the ¹O₂ signals shown are background corrected using the reference measurements at 1200 ± 15 nm (FWHM).

### Phototoxic Experiments

For PDI experiments with microorganisms, the samples were divided into four groups: (1.) irradiated PS-doped samples under defined irradiation conditions, (2.) similarly treated but unirradiated dark controls, and (3.) irradiated and (4.) unirradiated zero samples (Ref-PET). The experiments were performed either semi-quantitatively with the Gram-positive airborne germ Micrococcus luteus (M. luteus) by visual assessment of bacterial colonization or quantitatively with a wild-type Gram-negative Escherichia coli (E. coli) using a plate counting procedure. All phototoxicity experiments were performed on samples disinfected with 70% EtOH under sterile conditions and repeated at least three times. Irradiation of the samples was performed using a white light irradiation system (emission between 400 and 800 nm) at 11 ± 2 mW/cm² for a maximum of one hour.

### Results

In the following, the textile fabric (PS-PET) functionalized with binder in the impregnation process and post-treated is characterized with regard to its PS doping and PS binding stability and compared with two non-post-treated samples dyed with and without binder (PS-PET* and PS-PET**). Subsequently, the sample PS-PET is investigated with regard to its ¹O₂ generation and its antimicrobial effect is quantified.

### Immobilization of TMPyp

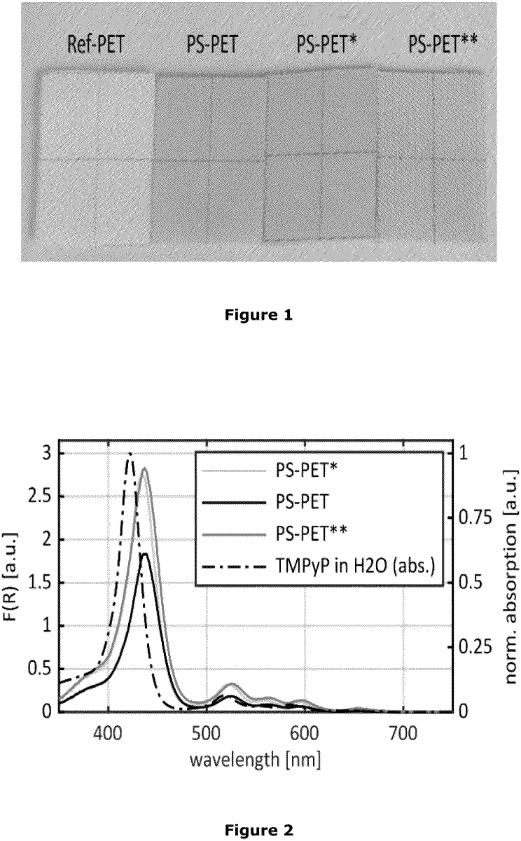

The sample PS-PET functionalized with binder and post-treated shows a clear and homogeneous TMPyP staining. The post-treatment to increase the fastness to washing removes only a little PS and the sample appears somewhat paler, as shown by comparison with two samples stained with (PS-PET*) and without (PS-PET**) binder system that have not been post-treated (see FIG. 1). In the staining itself, the use of the binder system does not yet show any advantage.

As shown in FIG. 2, the relative color impression is confirmed by the DRUV spectra. Thereby, the characteristic TMPyP absorption spectrum is recognizable for all three samples. Compared to TMPyP in aqueous solution, the reflectance spectra show a bathochromic effect of about 10 nm. This can be attributed to the altered microenvironment of the PS. The hypochromic effect and the broadening of the Soret bands are also due to the adsorption of TMPyP onto the textile fibers.

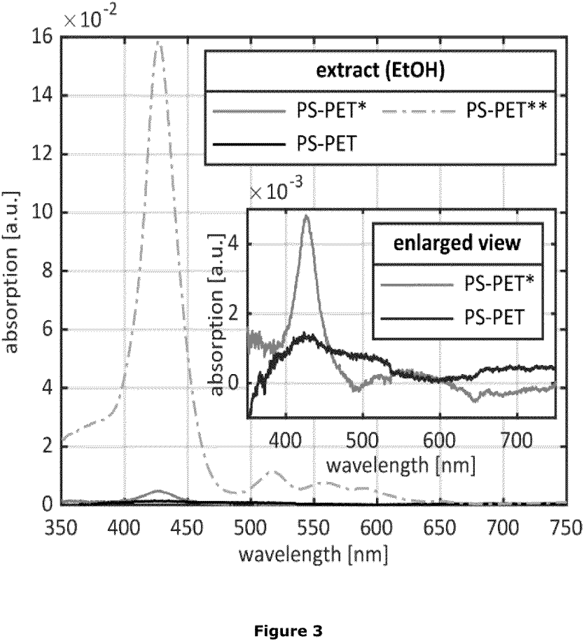

Extraction experiments to validate PS immobilization were performed in H₂O, PBS, EtOH and E. coli bacterial suspension and compared with the samples PS-PET* (no post-treatment) and PS-PET** (no post-treatment and no binder system). No bleeding of TMPyP of the sample PS-PET was detected. This is not the case for the non-post-treated fabrics functionalized with and without binder system. FIG. 3 shows their TMPyP extraction using EtOH as an example, which exhibited the greatest bleeding. Here, the PS on the sample without binder system is the worst immobilized. The sample stained in the binder system and post-treated shows no PS extraction within the measurement sensitivity.

### Characteristics of ¹O₂ Generation

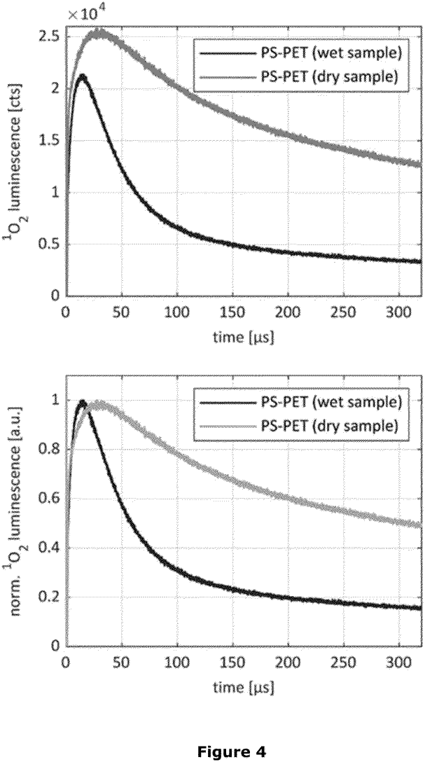

Scans of NIR luminescence on the sample surface show clear ¹O₂ signals with characteristic onset and decay of the kinetics (see FIG. 4). Control measurements at 1200 ± 15 nm (FWHM) showed negligible PS phosphorescence signals, so that an oxygen depletion could be ruled out. Nevertheless, the signals in both dry and wet states are dominated by very long decay times above 50 µs. The ¹O₂ decay in air as well as a possible diffusion-limited oxygen transport in the PET substrate may be responsible for this. By the normalized plot (reproduced on the right in FIG. 4), it is clear that the ¹O₂ kinetics are influenced by the aqueous microenvironment of the samples scanned in the wet state. Both onset and decay are significantly shorter than for a sample scanned in the dry state. Thus, it can be assumed that the generated ¹O₂ can leave the substrate and is available for the PDI of microorganisms.

### Antimicrobial Activity Upon Irradiation With White Light

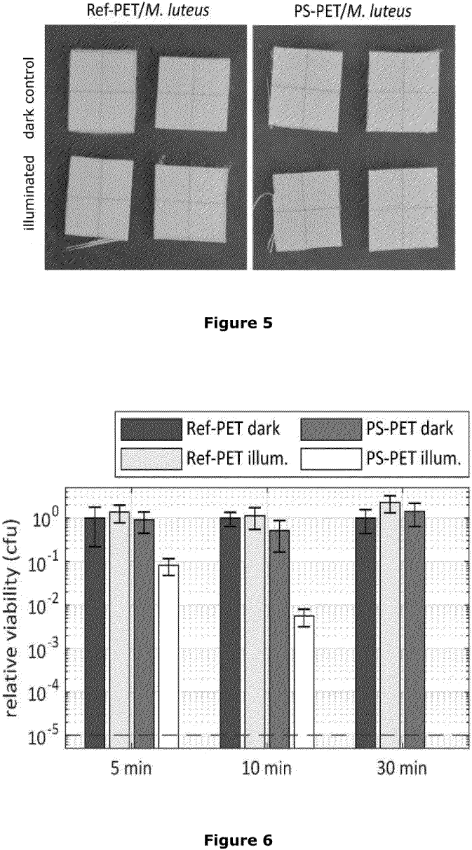

In the hand test with the yellow airborne germ M. luteus, the sample shows a complete germicide after one hour of irradiation with white light (see FIG. 5). Both the (originally white) irradiated and unirradiated zero samples and the unirradiated PS-PET samples are completely covered with a yellow film of M. luteus. No bacteria could be identified on the irradiated PS-PET samples.

The quantitative evaluation of the PDI against the E. coli also shows a complete light-induced germicide after 30 minutes within the framework of the experiment (see FIG. 6). Already after ten minutes of irradiation the phototoxicity is about two log10 levels, after 30 minutes at least five log levels. No dark toxic effect could be observed. Thus, this sample can be classified as antimicrobial after ten to 30 minutes of white light irradiation with only 11 ± 2 mW/cm².

### Conclusions

The impregnation of the commercial PET fabric in the foulard process with TMPyP results in homogeneous dyeing of the textile. The post-treatment washes out poorly bonded PS and increases the washing resistance. As a result, no PS bleeding was observed within the extraction tests carried out with H₂O, PBS, EtOH and bacterial suspension with E. coli. This is particularly critical since the cationic TMPyP has a high affinity for Gram-negative cell walls. The spectroscopic characterization of the PS-PET tissues shows that the photophysical activity of TMPyP is retained after functionalization. The TMPyP on the tissue is capable to generate ¹O₂. Time-resolved ¹O₂ scans under altered microenvironment (dry and wet samples) prove that the generated ¹O₂ can leave the tissue. The tissue functionalized with TMPyP is capable of a complete germicide of a Gram-positive airborne germ and the Gram-negative model bacterium E. coli. via PDI. Quantification of phototoxicity shows cell inactivation of at least five log levels after only 30 minutes of white light irradiation.

The present disclosure has been described with reference to specific embodiments and examples. However, the disclosure is not limited thereto and various modifications thereof are possible without departing from the scope of the present disclosure.

1. A textile fabric, comprising;
a woven and/or nonwoven fabric,
wherein the woven and/or nonwoven fabric comprises fibers,
wherein a dye, which has an antimicrobial effect when activated with electromagnetic radiation, is bonded to the fibers .

2. The textile fabric according to claim 1, wherein the dye is adsorbed to the fibers .

3. The textile fabric according to claim 1, wherein the dye is bonded to the fibers via ionic interactions and/or covalently.

4. The textile fabric according to claim 1, wherein the fibers are partially negatively charged and the dye is partially positively charged, or wherein the fibers are partially positively charged and the dye is partially negatively charged.

5. The textile fabric according to claim 1, wherein the fibers comprise at least one of polyester fibers and cellulose fibers.

6. The textile fabric according to claim 1, wherein the dye is selected from the group consisting of a porphyrin dye, a xanthene dye, and a phthalocyanine dye.

7. The textile fabric according to claim 1, wherein the dye is selected from the group consisting of TMPyP, Eosin Y, Rose Bengal, and ZnPcF16.

8. An article of clothing, comprising:
a fabric,
wherein the fabric comprises fibers,
wherein a dye, which has an antimicrobial effect when activated with electromagnetic radiation, is bonded to the fibers.

9. The article of clothing according to claim 8, wherein the article of clothing is at least one of protective clothing, workwear, and cleanroom clothing.

10. A method of functionalizing a textile fabric comprising a woven and/or nonwoven fabric comprising fibers, the method comprising the steps of:
optionally at least partially coating the fibers;
applying a dye, which has an antimicrobial effect when activated with electromagnetic radiation, to the textile fabric; and
binding the dye to the fibers or to and/or in the coating.

11. The method according to claim 10, wherein applying the dye includes impregnating the textile fabric with a composition comprising the dye.

12. The method according to claim 10, wherein binding the dye comprises at least one of the following features:
an occurrence of ionic interactions between the dye and the fibers or the coating;
a chemical reaction to form a covalent bond between reactive groups of the dye and reactive groups of the fibers or the coating;
an embedding of the dye in a polymer matrix of the coating.

13. The method according to claim 10, further comprising:
removing unbonded dye.

14-15. (canceled)

16. The textile fabric according to claim 1, wherein the fibers have at least in part a coating, wherein the dye is bonded to and/or in the coating.

17. The textile fabric according to claim 16, wherein the dye is adsorbed to a surface of the coating and/or embedded therein.

18. The textile fabric according to claim 16, wherein the dye is bonded to the coating via ionic interactions and/or covalently.

19. The textile fabric according to claim 1, wherein the dye is bonded to the fibers via ionic interactions, wherein the dye is selected from the group consisting of a porphyrin dye and a phthalocyanine dye.

20. The textile fabric according to claim 1, wherein the dye is directly bonded to the fibers.

21. The textile fabric according to claim 1, wherein the dye is directly bonded to the fibers via ionic interactions.

22. The textile fabric according to claim 1, wherein the dye is directly bonded to the fibers via ionic interactions, wherein the dye is selected from the group consisting of a porphyrin dye and a phthalocyanine dye.
